(19) United States
(12) Patent Application Publication
(10) Pub. No.: US 2015/0088595 A1
(43) Pub. Date: Mar. 26, 2015

(54) Systems and Methods for Evaluating Risks Associated with a Contractual Service Agreement

(71) Applicant: General Electric Company, Schenectady, NY (US)

(72) Inventors: Rahul J. Chillar, Atlanta, GA (US); LeeAnn Crull, Atlanta, GA (US)

(73) Assignee: General Electric Company, Schenectady, NY (US)

(21) Appl. No.: 14/036,715

(22) Filed: Sep. 25, 2013

(51) Int. Cl. G06Q 10/06

(52) U.S. Cl. CPC G06Q 10/0635
USPC 705/7.28

(57) ABSTRACT

Systems and methods for evaluating risks associated with a contractual service agreement are provided. According to one embodiment, a system may include a processor configured to analyze the contractual service agreement to determine risk categories associated with the contractual service agreement. The system may receive risk parameters associated with the one or more risk categories and weights associated with the one or more risk parameters. The weights may be associated with the risk parameters to produce weighted risk parameters. The risk associated with the contractual service agreement may be evaluated by adding the weighted risk parameters.

### TECHNICAL FIELD

This disclosure relates generally to data processing and, more specifically, to systems and methods for evaluating risks associated with a contractual service agreement.

### BACKGROUND

Increasing market competition may force power generating companies to concentrate their efforts on their respective core business while delegating the operation and maintenance of power plants to equipment manufacturers. This approach may increase profitability and decrease risks associated with operation and maintenance. Long term service agreements between power suppliers and equipment manufacturers are often required to specify the terms of the agreement. Typically, a long term service agreement can provide each customer with certain guarantees including availability, reliability, maintenance costs, power output, heat rate, and so forth, for several years to come. The terms of the agreement may also specify routine and emergency maintenance procedures and frequency to guarantee a certain level of plant operation and to prevent any possible breakdowns and failures in operation.

Since long term service agreements can involve millions of dollars, in some instances, a detailed cost analysis is performed before any decision is made. Even though long term service agreements may cover most maintenance, risks associated with unplanned maintenance, creditworthiness of the customer, and external conditions outside of the control of any of the involved parties can be extremely high.

### BRIEF DESCRIPTION OF THE DISCLOSURE

The disclosure relates to systems and methods for evaluating risks associated with a contractual service agreement. According to one embodiment, a system for evaluating risks associated with a contractual service agreement may be provided. The system may include a processor and a memory comprising computer-readable instructions for execution by the processor. The processor may be configured to analyze the contractual service agreement to determine one or more risk categories associated with the contractual service agreement. The processor may be further configured to receive one or more risk parameters associated with the one or more risk categories and to receive one or more weights associated with the one or more risk parameters. The processor may be further configured to associate the one or more weights with the one or more risk parameters to produce one or more weighted risk parameters and score the risk by adding the one or more weighted risk parameters to produce a risk score associated with the contractual service agreement.

In one embodiment, a method for evaluating risks associated with a contractual service agreement may be provided. The method may commence with analyzing the contractual service agreement to determine one or more risk categories associated with the contractual service agreement. The method may include receiving one or more risk parameters associated with the one or more risk categories and receiving one or more weights associated with the one or more risk parameters. The method may further include associating the one or more weights with the one or more risk parameters to produce one or more weighted risk parameters. Finally, the risk may be scored by adding the one or more weighted risk parameters to produce a risk score associated with the contractual service agreement.

In one embodiment, provided is a non-transitory computer-readable medium comprising instructions, which when executed by one or more processors, perform the following operations. In one operation, one or more risk parameters associated with the one or more risk categories may be received. In further operation, one or more weights associated with the one or more risk parameters may be received. In another operation, the one or more weights may be associated with the one or more risk parameters to produce one or more weighted risk parameters. In yet another operation, financial values for the one or more upgrade opportunities may be calculated. In yet another operation, the risk may be scored by adding the one or more weighted risk parameters to produce a risk score associated with the contractual service agreement.

Other embodiments, features, and aspects will become apparent from the following description taken in conjunction with the following drawings.

### BRIEF DESCRIPTION OF THE DRAWINGS

FIG. 1 depicts a simplified block diagram illustrating an example environment within which systems and methods for evaluating risks associated with a contractual service agreement may be implemented, in accordance with an embodiment of the disclosure.

FIG. 2 depicts a simplified block diagram illustrating modules of an example system for evaluating risks associated with a contractual service agreement, in accordance with an embodiment of the disclosure.

FIG. 3 depicts a process flow diagram illustrating an example method for evaluating risks associated with a contractual service agreement, in accordance with an embodiment of the disclosure.

FIG. 4 depicts a graph illustrating an example relationship between risk scores and availability rates of an example power plant, in accordance with an embodiment of the disclosure.

FIG. 5 depicts an example report showing portfolio deferred balances by categories, in accordance with an embodiment of the disclosure.

FIG. 6 depicts a schematic diagram illustrating an example computer system for performing any one or more of the methods discussed herein.

### DETAILED DESCRIPTION

The following detailed description includes references to the accompanying drawings, which form part of the detailed description. The drawings depict illustrations in accordance with example embodiments. These example embodiments, which are also referred to herein as “examples,” are described in enough detail to enable those skilled in the art to practice the present subject matter. The example embodiments may be combined, other embodiments may be utilized, or structural, logical, and electrical changes may be made, without departing from the scope of the claimed subject matter. The following detailed description is, therefore, not to be taken in a limiting sense, and the scope is defined by the appended claims and their equivalents.

The embodiments described herein relate to systems and methods for evaluating risks associated with a contractual service agreement. Power energy suppliers strive to keep operating costs low while operating plants as efficiently as possible. Operating costs are critical in determining the profitability of a plant; however, unplanned maintenance events can increase costs and make operating the plant economically unsound. For this reason, customers often delegate operations and/or maintenance to the manufacturers of their plants in order to increase profit and decrease risk. To evaluate the costs associated with the operations and maintenance, the manufacturers can evaluate costs of planned and unplanned maintenance activities, which may be caused, for example, by equipment's normal wear, sudden transient events, manufacturing or quality issues, repairs, and inspections, all of which can add considerable costs over a period of time.

In many cases, customers may require the manufacturers to provide an extended warranty and/or enter into a long term contractual service agreement. Long term contractual service agreements may last for an extended number of years and offer a number of benefits. The customer can be provided with an estimate of maintenance costs and be guaranteed efficient maintenance, periodic updates, and training. Although a manufacturer may be spending millions on the contract, there still might be high unexpected costs. In certain instances, a detailed cost/risk evaluation analysis can be carried out before any decision is reached.

In one embodiment, a system for evaluating risks associated with a contractual service agreement is provided. The system may include a processor configured to evaluate the risk associated with a contractual service agreement and a memory comprising computer-readable instructions for execution by the processor. The risk may be of two main types: a commercial risk and an operational risk. The commercial risk may include the risk of losing the whole or a part of the agreement (termination or retirement) or restructuring (renegotiation) of the agreement. The operational risk may include the volatility of agreement profitability (for example, margin leakage or margin adjustments). Both the commercial risk and operational risk may be measured for long term contractual service agreements by defining the risks as a function of various parameters. These multiple parameters may be intelligently chosen, given different weights, and then added together to yield a single risk score associated with the contractual service agreement for commercial and operational risk measurement.

By evaluating the risk score associated with the contractual service agreement, an Original Equipment Manufacturer (OEM) may identify, review, and manage risk of existing and future agreements on a contract level, customer level, and portfolio level. Based on the evaluated risk, a future strategy may be set forth with regard to some or all of the following main points:
assess and measure risk in the following risk categories: macroeconomic risk, credit risk, customer behavior risk, and technical execution risk;
assess acceptable risk to match business vision, business strategy, and business objectives;
create an operating rhythm to provide transparency around emerging risks, establish a risk factor steering committee, and review risk factors at the contract, customer, and portfolio level;
prioritize and address risks, assess acceptable risk level, and understand the business benefit of accepting or mitigating the risk; and
establish a process for knowledge transfer.

In one example embodiment, the above-indicated risk categories (macroeconomic risk, credit risk, customer behavior risk, and technical execution risk) may be further divided into sub-categories, and each category and sub-category may be associated with a certain weight.

In one example embodiment, the sub-category may include a product maturity risk. For more mature equipment, power producers may try to obtain benefits from third party providers that are comparable to the benefits offered by the manufacturers under the long term service agreements. For relatively newer technologies, customers are more likely to remain with the manufacturers within long term service agreements.

In one example embodiment, a sub-category may include a thermal performance of units. If a unit is operating at higher efficiency and output, the customer may continue the relationship with a long term service agreement, because the customer can save a considerable amount of money on fuel and operation.

In one example embodiment, the sub-category may include customer behavior. A customer that is technically sound or is building a relatively good operations and management crew for a power plant may choose to cancel a long term service agreement as he will know how to manage this technology. On the other hand, a customer, such as a bank, may own a power plant, and may want an OEM to continue operating and managing the plant under a long term service agreement.

In one example embodiment, the sub-category may include an OEM/customer relationship. Customers may wish to operate together with the OEM, creating and strengthening a strong interconnection leading to a long lasting partnership through a long term service agreement, rather than establishing a mere customer/supplier relationship with low added value for both. Example embodiments of the disclosure will now be described with reference to the accompanying figures.

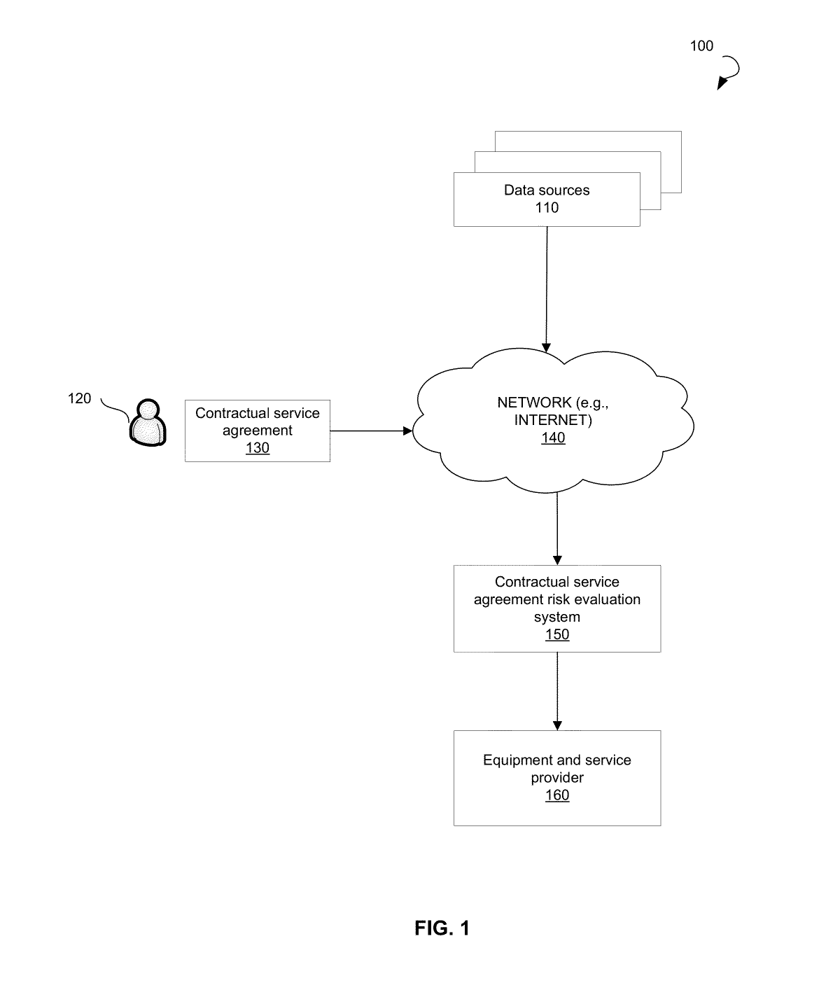

Referring now to FIG. 1, a simplified block diagram illustrating an example environment 100 within which systems and methods for evaluating risks associated with a contractual service agreement may be implemented, in accordance with one or more example embodiments.

As shown in FIG. 1, a contractual service agreement risk evaluation system 150 is configured to evaluate a risk associated with one or more existing contractual service agreements. The risk may be evaluated for an individual contractual service agreement, several contractual service agreements owned by the same customer 120, or a portfolio of agreements associated with a specific region, country, or technology.

In one example embodiment, data associated with a contractual service agreement 130 may be provided to the risk evaluation system 150 by a customer 120. The data may be provided via a network 140, which may correspond to any type of network, including but not limited to a dial-in network, a utility network, public switched telephone network (PSTN), a local area network (LAN), wide area network (WAN), metropolitan area network (MAN), personal area network (PAN), virtual private network (VPN), campus area network (CAN), storage area network (SAN), the Internet, intranet or Ethernet type networks, and combinations of two or more of these types of networks or others, implemented with any variety of network topologies in a combination of one or more wired and/or wireless communication links.

Alternatively, the data associated with a contractual service agreement 130 may be stored on a server associated with the risk evaluation system 150. In one example embodiment, the risk evaluation system 150 may be further configured to receive, via the network 140, data relating to different economic and financial aspects that may influence the risk evaluation of the contractual service agreement 130, such as country economic rankings, customer credit history, customer financial status, service execution level, and other statistical information from one or more external data sources 110, such as ERAM (Moody's) system, customer credit web sites, International Finance Corporation website, International Monetary Fund website, and so forth.

In one example embodiment, the risk evaluation system 150 may include an onsite monitoring system (not shown) interfaced with a plurality of sensors that are provided within a plant for tracking and capturing various monitored operating parameters of the plant. The monitoring system may be configured to monitor and collect plant operational data and transfer the operational data to the server associated with the risk evaluation system 150. The operational data may include historical operation data of the plant as well as the latest actualized year operational data of the plant.

Based on the data associated with the contractual service agreement 130, data from external sources, and plant operational data, the risk evaluation system 150 may calculate a risk score for the contractual service agreement 130. The results of the risk evaluation may be provided to an equipment and service provider 160 in the form of a report. The report may include a contract report, a portfolio comparison report, a total risk score report, a deferred balance report, a risk-weighted score dashboard report, and/or a combination thereof.

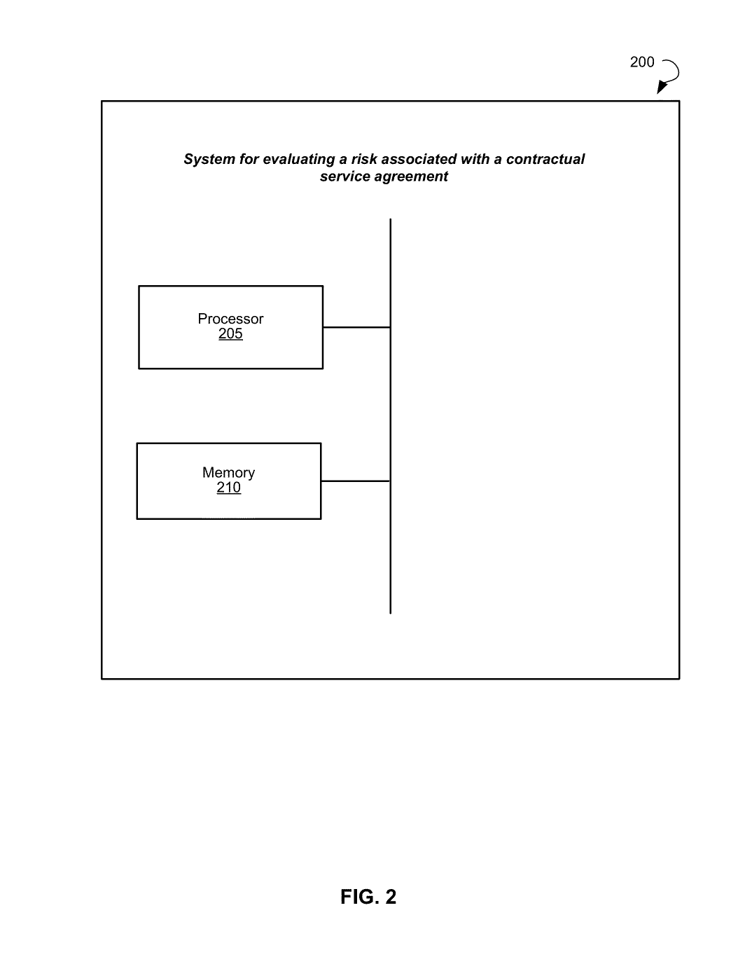

FIG. 2 depicts a simplified block diagram illustrating modules of a system 200 for evaluating risks associated with a contractual service agreement, such as 130 in FIG. 1, in accordance with an embodiment of the disclosure. More specifically, the system 200 for evaluating risks associated with a contractual service agreement may include a processor 205 and a memory 210. The processor 205 may execute instructions for software that may be loaded into the memory 210. The processor 205 may be a set of one or more processors or may include multiple processor cores, depending on the particular implementation. Further, the processor 205 may be implemented using one or more heterogeneous processor systems in which a main processor is present with secondary processors on a single chip. In another embodiment, the processor 205 may be a homogeneous processor system containing multiple processors of the same type. Instructions for the operating system and applications or programs may be located in the memory 205. These instructions may be loaded into the memory 210 for execution by the processor 205. The processes of the different embodiments may be performed by the processor 205 using computer-implemented instructions and/or computer-executable instructions, which may be located in the memory 210. These instructions may be referred to as program code (e.g., object code and/or source code) that may be read and executed by the processor 205. The program code in the different embodiments may be embodied on different physical or tangible computer readable media.

In one example embodiment, the processor 205 may be configured to analyze the contractual service agreement to determine one or more risk categories associated with the contractual service agreement. The one or more risk categories may include one or more of the following: a credit risk, a customer behavior risk, a macroeconomic risk, and a technical execution risk.

Under the credit risk category, the system 200 may measure the financial health of a customer and how the financial health may affect customer's ability to fulfill contractual obligations (i.e., payment). The output may be a customer watch list, bankruptcy indicator, customer credit/past dues, customer financial health, and so forth.

Under the customer behavior risk category, the system 200 may measure agreement competitiveness and asset competitiveness in the market. The output may be a value of contract versus transactional service arrangement and operational changes in the utilization, which may impact agreement margin.

Under the macroeconomic risk category, the system 200 may measure the overall market environment in which a customer is operating and how that broadly affects the customer or agreement. The output may be economic indicators that provide a measure of the overall health of a country's economy.

Under the technical execution risk category, the system 200 may measure the execution of a company's products and services. The output may be the frequency of unplanned outages and trips.

In one example embodiment, the processor 205 may further be configured to receive one or more risk parameters associated with the one or more risk categories. The one or more risk parameters may be based at least in part on a customer and a service portfolio associated with the contractual service agreement.

In one example embodiment, the processor 205 may further be configured to receive one or more weights associated with the one or more risk parameters. The one or more weights may be based at least in part on historical data, associated with the one or more risk categories, a business vision, a business strategy, and a business objective.

In one example embodiment, the processor 205 may further be configured to associate the one or more weights with the one or more risk parameters to produce one or more weighted risk parameters. In one example embodiment, the processor 205 may further be configured to score the risk by adding the one or more weighted risk parameters to produce a risk score associated with the contractual service agreement. In one example embodiment, the processor 205 is further configured to set a future strategy based on the score.

In one example embodiment, the processor 205 may be further configured to receive a feedback associated with the contractual service agreement and reevaluate the risk based on the feedback. In one example embodiment, the processor 205 may be further configured to compare the risk with one or more risks associated with one or more further contractual service agreements and prioritize the contractual service agreement based at least in part on the comparing. In one example embodiment, the processor 205 is further configured to compare the risk score to a threshold tolerance score and determine whether to proceed with the contractual service agreement based on the comparing.

In one example embodiment, the processor 205 is further configured to generate one or more reports based on the risk score associated with the contractual service agreement. The one or more reports may include one or more of the following: a contract report, a portfolio comparison report, a total risk score report, a deferred balance report, and a risk-weighted score dashboard report.

In one example embodiment, the memory 210 may include a storage device. As used herein, the storage device may be any piece of hardware that is capable of storing information either on a temporary basis and/or a permanent basis. The memory 210 may be a random access memory (RAM) and/or any other suitable volatile or nonvolatile storage device. Further, the memory 210 may take various forms depending on the particular implementation, and the memory 210 may contain one or more components or devices. The media used by the memory 210 may also be removable (for example, a removable hard drive). The memory 210 may be configured to store data for use with the processes described herein. For example, the memory 210 may store one or more software applications (e.g., including source code and/or computer-executable instructions) such as a virtual machine and/or other software application and/or any other information suitable for use with the methods described herein.

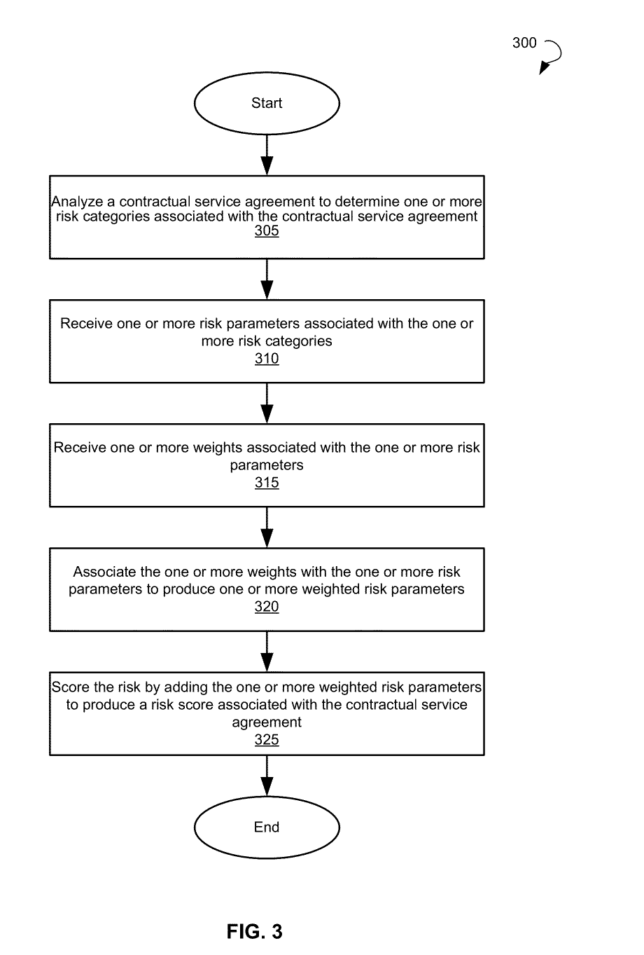

FIG. 3 depicts a process flow diagram illustrating an example method for evaluating risks associated with a contractual service agreement, in accordance with an embodiment of the disclosure. The method 300 may be performed by processing logic that may comprise hardware (e.g., dedicated logic, programmable logic, and microcode), software (such as software run on a general-purpose computer system or a dedicated machine), or a combination of both.

As shown in FIG. 3, the method 300 may commence at operation 305 with analyzing the contractual service agreement to determine one or more risk categories associated with the contractual service agreement. Principal risk categories that may have major impact on a contractual service agreement may include, but are not limited to, a credit risk, a customer behavior risk, a macro economic risk, and a technical execution risk.

In one example embodiment, the method 300 may proceed with receiving one or more risk parameters associated with the one or more risk categories, at operation 310. The risk parameters may include ratings and default frequencies reported by credit agencies, watch lists, a past due balance caused by the customer's inability to pay, economic rankings, economic indicators (annual growth, domestic product growth, unemployment rate), market environment, financial health of a customer, capacity utilization, net present value (NPV), historical operation of a plant versus latest actualized year plant operation, duration of frequency of forced outages, availability of a unit, reliability of a unit, and so forth.

In one example embodiment, the method 300 may proceed with receiving one or more weights associated with the one or more risk parameters, at operation 315. Weights may be provided by a customer or may be determined based at least in part on historical data associated with risk categories, business vision, business strategy, business objective, and the like. At operation 320, the one or more weights may be associated with the one or more risk parameters to produce one or more weighted risk parameters.

Finally, at operation 325, the risk may be scored by adding the one or more weighted risk parameters to produce a risk score associated with the contractual service agreement. The risk score may be then used to set a future strategy of accepting or mitigating the risk.

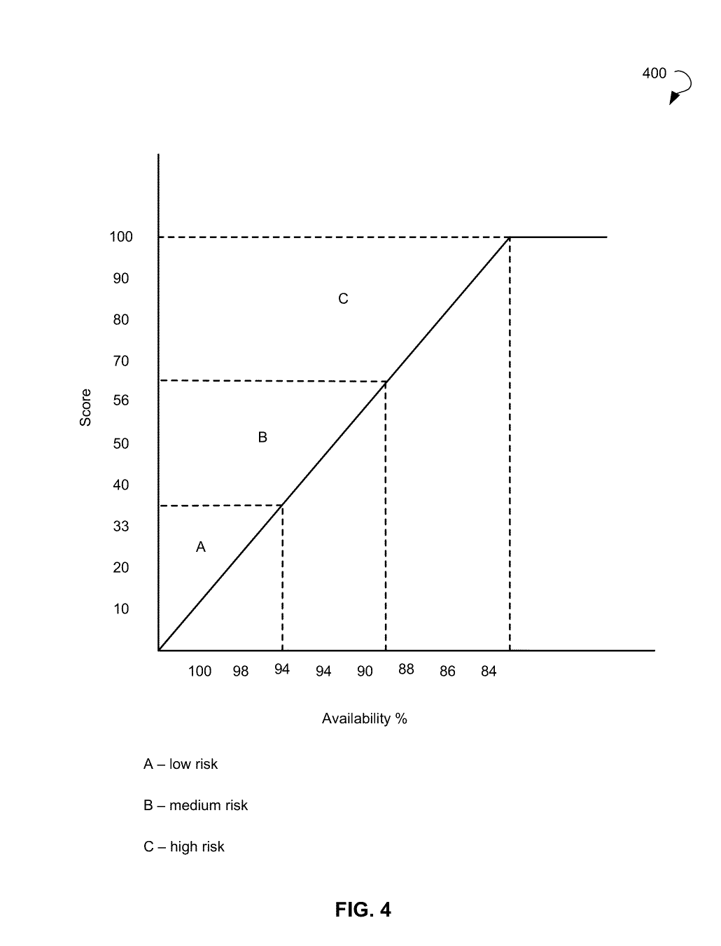

FIG. 4 depicts a graph 400 illustrating an example relationship between risk scores and availability rates of a unit or power plant, in accordance with an embodiment of the disclosure. Specifically, FIG. 4 shows the dependence of the risk score on the unit availability rate. The availability rate of the unit may be calculated for a certain time interval using operating data associated with the unit, such as a number of forced outage events, a number of total trips per unit, and the like. The graph 400 contains three areas of risk level: low risk (area A), medium risk (area B), and high risk (area C). For example, if the calculated availability rate of a unit for the last four quarters is about 90.9%, the risk score will fall under the medium risk area.

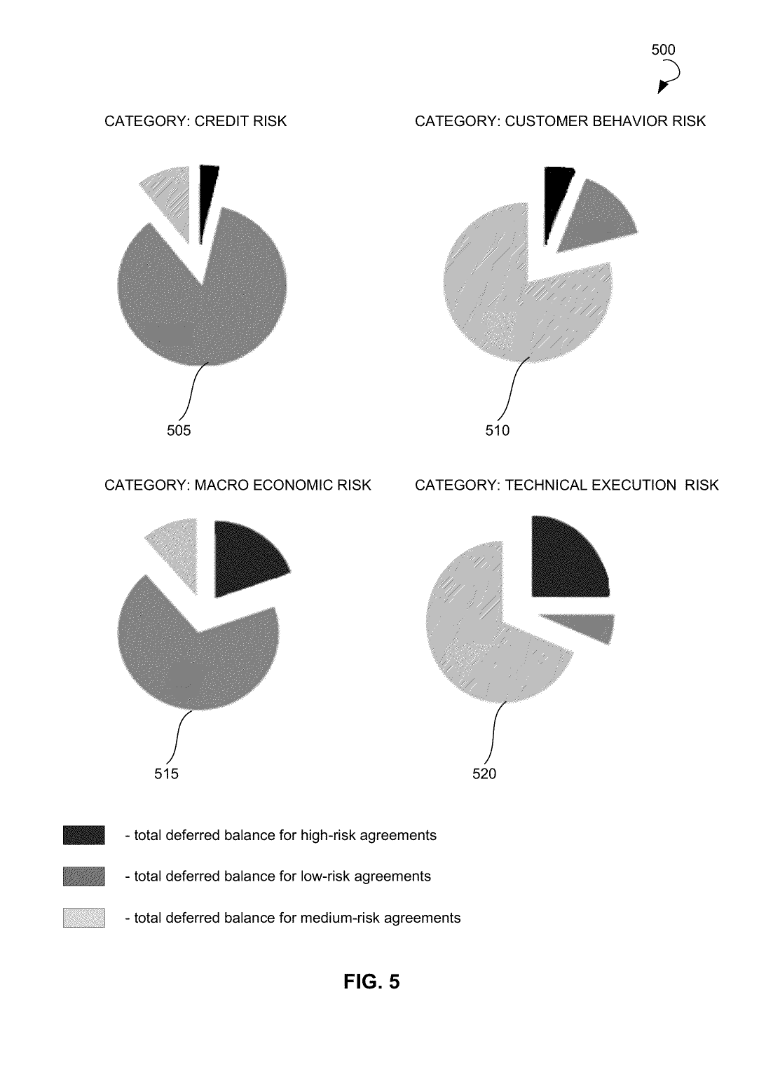

FIG. 5 depicts an example report 500 showing portfolio deferred balances by categories, in accordance with an embodiment of the disclosure. In one example embodiment, the system, such as 200 in FIG. 2, for evaluating risks associated with a contractual service agreement may be configured to generate one or more reports based at least in part on the risk score associated with the contractual service agreement. The one or more reports may include a contract report, a portfolio comparison report, a total risk score report, a deferred balance report, a risk-weighted score dashboard report, and/or a combination thereof.

In one example embodiment, the contract report may enable a user to make an analysis for every individual agreement in the portfolio. The system may require a user to provide a model ID In order to generate the contract report. Based on the model ID, the system may calculate a risk score by adding the weighted risk parameters in all risk categories. In one example embodiment, the portfolio comparison report may enable a user to see the total number of high-risk, medium-risk, and low-risk agreements under a specific region, country, or technology. Additionally, the user may make a comparison between four-quarter and three-quarter data in the same sheet.

In one example embodiment, the total risk score report may show current risk scores per risk category and also risk scores of a prior quarter. Additionally, a user may choose a specific region, country, or technology. In one example embodiment, the deferred balance report may show a user the distribution of deferred balance by risk level under each category. Additionally, the report may show the deferred balance under a specific region, country, or technology.

An example of the deferred balance report 500 is schematically represented on FIG. 5. Four circular diagrams 505, 510, 515, and 520 are shown, with each corresponding to a specific risk category: a credit risk, a customer behavior risk, a macro economic risk, and a technical execution risk. Each section of the circular diagrams represents a percentage of contractual service agreements in a portfolio having low, medium, or high risk. For example, the graph 505 relating to the credit risk category shows a low percentage of high-risk agreements; the graph 520 relating to the technical execution risk category shows a high percentage of high-risk agreements in the portfolio. In one example embodiment, the risk-weighted score dashboard report may show risk levels of the riskiest agreements under one or more risk categories or regions. The report may also show the riskiest agreements by deferred balance for the selected region.

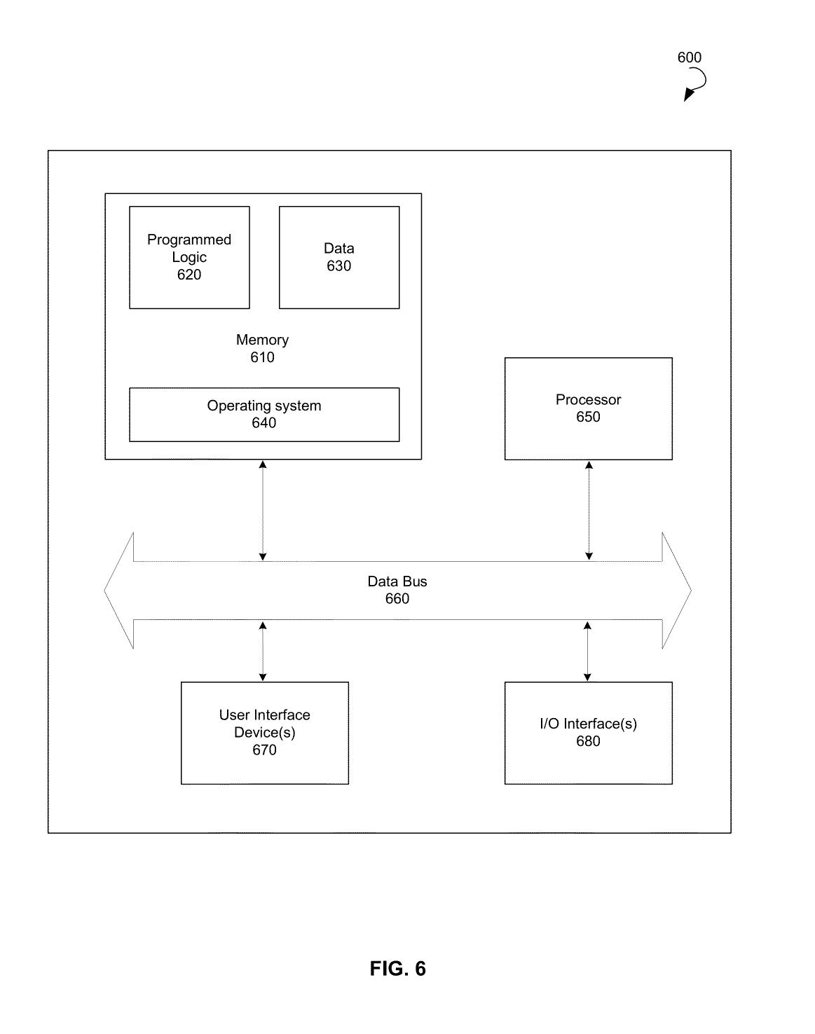

FIG. 6 depicts an example computer system 600 for performing any one or more of the methods discussed herein, in accordance with various embodiments of the disclosure. More specifically, elements of the computer system 600 may be used to implement systems and methods for evaluating risks associated with a contractual service agreement. The computer system 600 may include a memory 610 that stores programmed logic 620 (e.g., software) and may store data 630. The memory 610 also may include an operating system 640. A processor 650 may utilize the operating system 640 to execute the programmed logic 620, and in doing so, may also utilize the data 630. A data bus 660 may provide communication between the memory 610 and the processor 650. Users may interface with the computer system 600 via at least one user interface device 670 such as a keyboard, mouse, touchscreen, gesture control device, wearable computer, control panel, or any other device capable of communicating data to and from the computer system 600. The computer system 600 may be in communication with customer equipment and its associated devices online while operating, as well as in communication with the customer equipment and its associated devices offline while not operating, via an input/output (I/O) interface 680. More specifically, the computer system 600 may carry out the execution of model-based instructions for, but not limited to, providing command signals to certain devices of the customer equipment and/or its associated devices. The computer system 600 and the programmed logic 620 implemented thereby may include software, hardware, firmware, or any combination thereof. It should also be appreciated that multiple controllers or processors may be used in the computer system 600, whereby different features described herein may be executed on one or more different controllers or processors.

Accordingly, embodiments described herein facilitate systems and methods for evaluating risks associated with a contractual service agreement. References are made to block diagrams of systems, methods, apparatuses, and computer program products according to example embodiments. It will be understood that at least some of the blocks of the block diagrams, and combinations of blocks in the block diagrams, respectively, may be implemented at least partially by computer program instructions. These computer program instructions may be loaded onto a general purpose computer, special purpose computer, special purpose hardware-based computer, or other programmable data processing apparatus to produce a machine, such that the instructions, which execute on the computer or other programmable data processing apparatus, create means for implementing the functionality of at least some of the blocks of the block diagrams, or combinations of blocks in the block diagrams discussed.

The computer program instructions mentioned herein may also be stored in a computer-readable memory that can direct a computer or other programmable data processing apparatus to function in a particular manner, such that the instructions stored in the computer-readable memory produce an article of manufacture including instruction means that implement the function specified in the block or blocks. The computer program instructions may also be loaded onto a computer or other programmable data processing apparatus to cause a series of operational steps to be performed on the computer or other programmable apparatus to produce a computer implemented process, such that the instructions that execute on the computer or other programmable apparatus provide steps for implementing the functions specified in the block or blocks.

One or more components of the systems and one or more elements of the methods described herein may be implemented through an application program running on an operating system of a computer. They also may be practiced with other computer system configurations, including hand-held devices, multiprocessor systems, microprocessor based or programmable consumer electronics, mini-computers, mainframe computers, and so forth.

Application programs that are components of the systems and methods described herein may include routines, programs, components, data structures, and so forth that implement certain abstract data types and perform certain tasks or actions. In a distributed computing environment, the application program (in whole or in part) may be located in local memory or in other storage. In addition, or in the alternative, the application program (in whole or in part) may be located in remote memory or in storage to allow for circumstances where tasks are performed by remote processing devices linked through a communications network.

Many modifications and other embodiments of the example descriptions set forth herein to which these descriptions pertain will come to mind having the benefit of the teachings presented in the foregoing descriptions and the associated drawings. Thus, it will be appreciated that the disclosure may be embodied in many forms and should not be limited to the example embodiments described above. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A computer-implemented method for evaluating risks associated with a contractual service agreement, the method comprising:
analyzing, by a processor, the contractual service agreement to determine one or more risk categories associated with the contractual service agreement;
receiving, by the processor, one or more risk parameters associated with the one or more risk categories;
receiving, by the processor, one or more weights associated with the one or more risk parameters;
associating, by the processor, the one or more weights with the one or more risk parameters to produce one or more weighted risk parameters; and
scoring, by the processor, the risk by adding the one or more weighted risk parameters to produce a risk score associated with the contractual service agreement.

2. The method of claim 1, wherein the one or more risk categories include one or more of the following: a credit risk, a customer behavior risk, a macro economic risk, and a technical execution risk.

3. The method of claim 1, wherein the one or more weights are based at least in part on historical data associated with the one or more risk categories, a business vision, a business strategy, and a business objective.

4. The method of claim 1, further comprising setting a future strategy based on the score.

5. The method of claim 1, further comprising:
receiving a feedback associated with the contractual service agreement; and
reevaluating the risk based on the feedback.

6. The method of claim 1, wherein the one or more risk parameters are based at least in part on a customer and a service portfolio associated with the contractual service agreement.

7. The method of claim 1, further comprising:
comparing the risk with one or more further risks associated with one or more further contractual service agreements; and
prioritizing the contractual service agreement based on the comparing.

8. The method of claim 1, further comprising:
comparing the risk score to a threshold tolerance score; and
determining whether to proceed with the contractual service agreement based at least in part on the comparing.

9. The method of claim 1, further comprising generating one or more reports based at least in part on the risk score associated with the contractual service agreement.

10. The method of claim 9, wherein the one or more reports include one or more of the following: a contract report, a portfolio comparison report, a total risk score report, a deferred balance report, and a risk-weighted score dashboard report.

11. A system for evaluating risks associated with a contractual service agreement, the system comprising:
a processor;
a memory comprising computer-readable instructions for execution by the processor, wherein the processor is configured to:
analyze the contractual service agreement to determine one or more risk categories associated with the contractual service agreement;
receive one or more risk parameters associated with the one or more risk categories;
receive one or more weights associated with the one or more risk parameters;
associate the one or more weights with the one or more risk parameters to produce one or more weighted risk parameters; and
score the risk by adding the one or more weighted risk parameters to produce a risk score associated with the contractual service agreement.

12. The system of claim 11, wherein the one or more risk categories include one or more of the following: a credit risk, a customer behavior risk, a macro economic risk, and a technical execution risk.

13. The system of claim 11, wherein the one or more weights are based at least in part on historical data associated with the one or more risk categories, a business vision, a business strategy, and a business objective.

14. The system of claim 11, wherein the processor is further configured to set a future strategy based on the score.

15. The system of claim 11, wherein the processor is further configured to:
receive a feedback associated with the contractual service agreement; and
reevaluate the risk based on the feedback.

16. The system of claim 11, wherein the one or more risk parameters are based at least in part on a customer and a service portfolio associated with the contractual service agreement.

17. The system of claim 11, wherein the processor is further configured to:
compare the risk with one or more risks associated with one or more further contractual service agreements; and
prioritize the contractual service agreement based at least in part on the comparing.

18. The system of claim 11, wherein the processor is further configured to:
compare the risk score to a threshold tolerance score; and
determine whether to proceed with the contractual service agreement based on the comparing.

19. The system of claim 11, wherein the processor is further configured to generate one or more reports based on the risk score associated with the contractual service agreement, wherein the one or more reports include one or more of the following: a contract report, a portfolio comparison report, a total risk score report, a deferred balance report, and a risk-weighted score dashboard report.

20. A non-transitory computer-readable medium comprising instructions, which when executed by one or more processors, perform the following operations:
analyze a contractual service agreement to determine one or more risk categories associated with the contractual service agreement;
receive one or more risk parameters associated with the one or more risk categories;
receive one or more weights associated with the one or more risk parameters;
associate the one or more weights with the one or more risk parameters to produce one or more weighted risk parameters; and
score the risk by adding the one or more weighted risk parameters to produce a risk score associated with the contractual service agreement.
